(19) United States
(12) Patent Application Publication
(10) Pub. No.: US 2005/0159977 A1
(43) Pub. Date: Jul. 21, 2005

(54) System and method for facilitating compliance and persistency with a regimen

(75) Inventors: Barry Green, Canton, GA (US); Daniel Berman, Atlanta, GA (US); Royce Chandler, Canton, GA (US); Christopher Hambrick, Dallas, GA (US)

Correspondence Address: GREENBERG TRAURIG, LLP, 77 WEST WACKER DRIVE, SUITE 2500, CHICAGO, IL, 60601-1732, US

(73) Assignee: PharmaCentra, LLC, Atlanta, GA (US)

(21) Appl. No.: 10/758,856

(22) Filed: Jan. 16, 2004

(51) Int. Cl. G06F 17/60

(52) U.S. Cl. 705/2

(57) ABSTRACT

A system and method for facilitating compliance and persistency with a regimen, such as a medical regimen. An individual provides the system with contact information which is used by the system to address the issue of forgetfulness as a regimen failure source by providing a self-directed contact facility that facilitates regimen compliance with updates on contact days, time intervals, and channels specified by the individual. The system may also employ a comprehensive reporting apparatus that facilitates the monitoring of the individual's compliance with regimen.

### BACKGROUND

The following generally relates to a system and method for facilitating compliance and persistency with a regimen and, more particularly, with a prescribed medical regimen.

It is well recognized that it is difficult for individuals to generally maintain any regimen. In the case of medical regimens, such as a prescribed medical regimen, a lack of compliance may not only endanger the health of the individual but may also serve as a significant public health issue. Given such concerns, a wide variety of research and studies have been conducted to assess the sources of noncompliance with medical regimens as well as to devise processes and technological applications to address these findings. Various causes for noncompliance that have been identified in these efforts include side effects of the medications, cost of the medications, forgetfulness, number of medications prescribed, lack of a primary care physician, or lack of prescribed medication information given by the primary care physician.

With respect to technological applications for addressing one or more of these causes, a wide range of processes and systems have been proposed. By way of example, U.S. Pat. No. 4,695,954 discloses a special drug dispenser to be used by a patient in conjunction with a system that monitors the usage of the drugs by the patient. Another system is disclosed in U.S. Pat. No. 4,766,542 wherein patients are contacted by automatic telephone dialing and voice synthesizing equipment to remind them that their prescriptions need to be refilled. Still further, U.S. Pat. No. 5,390,238 discloses a system linking the physician, pharmacists, patient, and care provider for the purpose of monitoring medication usage and patient wellness. Yet further, U.S. Pat. No. 5,950,630 discloses a system wherein patient compliance is monitored in a process that relies upon computer and electronic communication systems to compare patient data and pharmaceutical data to verify prescribed drug dosage and prescribed medication duration are within acceptable limits. The system disclosed in U.S. Pat. No. 5,950,630 also provides for notifying the patient prior to the prescribed time for the prescribed drugs to be administered, notifying a prescription service to deliver the prescribed drugs to the patient, and notifying a service to pay for the prescribed drugs.

While systems such as those described above have found moderate effectiveness in facilitating patent compliance with a medical regimen, they do suffer the disadvantage of only focusing on monitoring, prompting, and evaluating usage. Thus, a need exists for a system and method for facilitating compliance and persistency with a regimen that, among other things, empowers the individual in the regimen process.

### SUMMARY

In accordance with this and other needs, the following describes a system and method for facilitating compliance and persistency with a regimen, such as a medical regimen. Generally, the foundation of the system and process is the empowerment of the individual/patient. In the context of medical regimens, the process inception may involve the diagnosis and prescription by the patient's physician of a specific drug and the capturing of specific contact preferences of the patient throughout the duration of the defined medical prescription regimen. Captured information, which is stored on a data storage media for use in connection with one or more computing devices, may include patient registration and contact data, pharmaceutical data, physician data, pharmacy data, patient prescription data, contact history data, patient credit card information, etc. Such information may then be utilized by the system and method to address the issue of forgetfulness as a failure source by providing a self-directed contact facility that facilitates regimen compliance with updates on contact days, time intervals, and channels specified by the patient. By way of example, these channels may include, but are not limited to, interactive voice response (i.e., computer driven calls), live calls, SMS/text messaging, e-mail, and direct mail. The system and method may also utilize the information to provide both an automated prescription refill and payment processing capability that allows the patient to apply technology to facilitate compliance to the prescribed regimen. Still further, the system and method may employ a comprehensive reporting apparatus that facilitates the monitoring of the patient usage of the prescribed drug by the physician, pharmaceutical company, regional pharmaceutical sales representative, medical educational/creative agencies, public health organizations and/or other third parties. The system and method may be used to additionally address the issue of unclear instructions or lack of written instructions by, for example, distributing regimen educational material both in the registration process and in subsequent contacts. It will also be appreciated that the system and method may provide for the communication of supplemental regimen information to the patient. The empowerment of the individual thus results from features such as an opt-in registration process that educates the patient on the drug regimen and allows the patient the ability to specify the time, day-of-the-week, and channel by which he or she would prefer to receive critical updates on the regimen, the ability of the individual patent to enable automatic prescription refill and payment processing capabilities that interface with the patient's designated pharmacist or pharmacy, and the like.

From the foregoing, it will be appreciated that, among others, the subject system and method has the advantage of providing a system that can facilitate the administration and capture of patient information and results relative to a prescribed medical regimens which may then provide a physician, drug manufacturer, and/or medical education research organization with key data relative to the medical regimen while maintaining adherence with HIPAA. Yet another advantage is found in the ability of the system to auto submit prescriptions to a pharmacy and/or pharmacist of the patient's designation based on the drug regimen dosage requirements as defined by the physician or drug manufacturer. A still further advantage is found in the ability of the system to facilitate payment processing for prescription auto refill capabilities through the complete submission, authorization, and remittance processes. Yet another advantage is found in the ability of the system to provide comprehensive reporting that will provide compliance and contact management reporting and analysis to a physician, drug manufacturer, medical education company and/or territory pharmaceutical sales representatives. A better understanding of these and other advantages, objects, features, properties and relationships of the system and method for facilitating compliance and persistency with a regimen will be obtained from the following detailed description and accompanying drawings which set forth illustrative embodiments which are indicative of the various ways in which the principles of the system and method may be employed.

### BRIEF DESCRIPTION OF THE DRAWINGS

A system and method for facilitating compliance and persistency with a regimen is described with reference to the following drawings in which:

FIG. 1 illustrates a process flow diagram of an exemplary method for recruiting physicians and capturing data for use in the system and method for facilitating compliance and persistency with a regimen;

FIG. 2 illustrates a process flow diagram of an exemplary method for developing scripts and surveys for capturing data for use in the system and method for facilitating compliance and persistency;

FIG. 3 illustrates a process flow diagram of an exemplary method for registering a patient with the system by means of an inbound phone call;

FIG. 4 illustrates a process flow diagram of an exemplary method for registering a patient with the system by means of a self-mailed registration;

FIG. 5 illustrates a process flow diagram of an exemplary method for registering a patient with the system by means of a Web-based registration;

FIG. 6 illustrates a process flow diagram of an exemplary method for using the system to manage patient contact and compliance;

FIG. 7 illustrates a process flow diagram of an exemplary method for using the system to manage the refill of patient prescriptions;

FIG. 8 illustrates a process flow diagram of an exemplary method for using the system to provide third party access to patient data and system statistics;

FIG. 9 illustrates a process flow diagram depicting system communications;

FIG. 10 illustrates a data flow diagram depicting data exchanged within the system; and

FIG. 11 illustrates a block diagram of an exemplary computer system in which the principles of the system and method for facilitating compliance and persistency with a regimen may be employed.

### DETAILED DESCRIPTION

Turning to the drawings, wherein like reference numerals refer to like elements, an exemplary system and method for facilitating compliance and persistency with a regimen is described. While described in the particular context of a system and method for facilitating compliance and persistency with a prescription medical regimen, it will be appreciated that this context is not intended to be limiting. Rather, it will be appreciated that aspects of the system and method that is to be described may be utilized to facilitate compliance and persistency with any type of individual regimen. Accordingly, the description is not intended to be limiting.

For performing various functions associated with the system and method for facilitating compliance and persistency with a regimen, one or more processing devices 20 are provided with executable instructions. Generally, the computer executable instructions reside in program modules, as illustrated in FIG. 11, which may include routines, programs, objects, components, data structures, etc. that perform particular tasks or implement particular abstract data types. Accordingly, those skilled in the art will appreciate that the processing device 20 may be embodied in any device having the ability to execute instructions such as, by way of example, a personal computer, mainframe computer, personal-digital assistant (“PDA”), cellular telephone, or the like. Furthermore, while described and illustrated in the context of a single processing device 20, those skilled in the art will also appreciate that the various tasks described hereinafter may be practiced in a distributed environment having multiple processing devices linked via a network whereby the executable instructions may be associated with and/or executed by one or more of the multiple processing devices.

To perform the various tasks in accordance with the executable instructions, the processing device 20 preferably includes a processing unit 22 and a system memory 24 which may be linked via a bus 26. Without limitation, the bus 26 may be a memory bus, a peripheral bus, and/or a local bus using any of a variety of bus architectures. By way of further example, the bus 26 may include an architecture having a North Bridge and a South Bridge where the North Bridge acts as the connection point for the processing unit 22, memory 24, and the South Bridge. The North Bridge functions to route traffic from these interfaces, and arbitrates and controls access to the memory subsystem from the processing unit 22 and I/O devices. The South Bridge, in its simplest form, integrates various I/O controllers, provides interfaces to peripheral devices and buses, and transfers data to/from the North bridge through either a PCI bus connection in older designs, or a proprietary interconnect in newer chipsets.

As needed for any particular purpose, the system memory 24 may include read only memory (ROM) 28 and/or random access memory (RAM) 30. Additional memory devices may also be made accessible to the processing device 20 by means of, for example, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated computer-readable media allow for the nonvolatile storage of computer readable instructions, data structures, program modules and other data for the processing device 20. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules may be stored in one or more of the memory/media devices. For example, a basic input/output system (BIOS) 44, containing the basic routines that help to transfer information between elements within the processing device 20, such as during start-up, may be stored in ROM 24. Similarly, the RAM 30, hard drive 38, and/or peripheral memory devices may be used to store computer executable instructions comprising an operating system 46, one or more applications programs 48, such as a program for performing simulated voice communications with a patient, other program modules 50, and/or program data 52.

A user may enter commands and information, such as patient data, into the processing device 20 through input devices such as a keyboard 54 and/or a pointing device 56. While not illustrated, other input devices may include a microphone, a joystick, a game pad, a scanner, etc. These and other input devices would typically be connected to the processing unit 22 by means of an interface 58 which, in turn, would be coupled to the bus 26. Input devices may be connected to the processor 22 using interfaces such as, for example, a parallel port, game port, firewire, or a universal serial bus (USB). To view information from the processing device 20, a monitor 60 or other type of display device may also be connected to the bus 26 via an interface, such as video adapter 62. In addition to the monitor 60, the processing device 20 may also include other peripheral output devices, not shown, such as speakers and printers.

The processing device 20 may also utilize logical connections to one or more remote processing devices, such as a processing device 20′ having an associated database 68. In this regard, while the remote processing device 20′ has been illustrated in the exemplary form of a computer, it will be appreciated that the remote processing device 20′ may be any type of device having processing capabilities. Again, it will be appreciated that the remote processing device 20′ need not be implemented as a single device but may be implemented in a manner such that the tasks performed by the remote processing device 20′ are distributed to a plurality of processing devices linked through a communication network For performing tasks as needed, the remote processing device 20′ may include many or all of the elements described above relative to the processing device 20. Communications between the processing device 20 and the remote processing device 20′ may be exchanged via a further processing device, such a network router 72, that is responsible for network routing. In this regard, communications with the network router 72 may be performed via a network interface component 73. Thus, within such a networked environment, it will be appreciated that program modules depicted relative to the processing device 20, or portions thereof, may be stored in the memory storage device(s) of the remote processing device 20′. Alternatively, it will be appreciated that the processing device 20 may itself have direct access to a database and include all of the modules necessary to perform the various functions described hereinafter.

The illustrated system may further include a telephone network interface 74 by which simulated voice communications may be made from the processing device 20 to a patient via a telephone network. In this regard, the patient may be contacted via a designated cell phone number, land-line number or the like without limitation. Additionally, the system may provide for communicating with the patient via the computer network by utilizing a firewall 75, Internet router 76, and network router 72. To this end, communications may be received at a processing device 21 designated by the patient and the communications may include emails, instant messages, alerts, and the like.

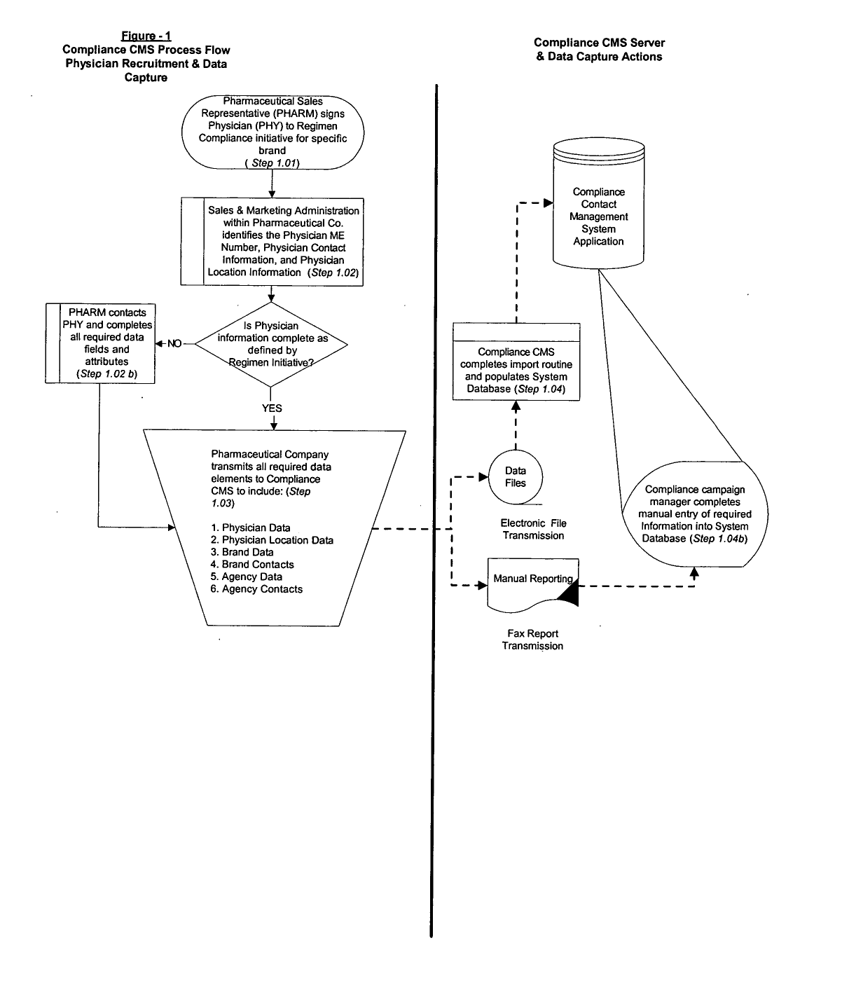

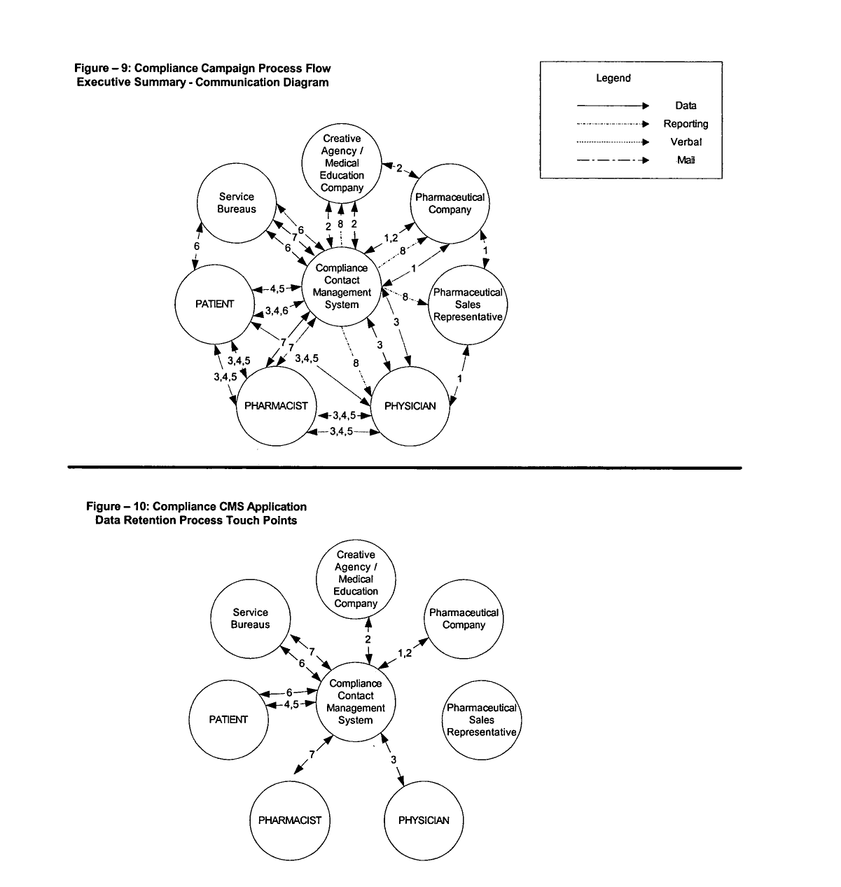

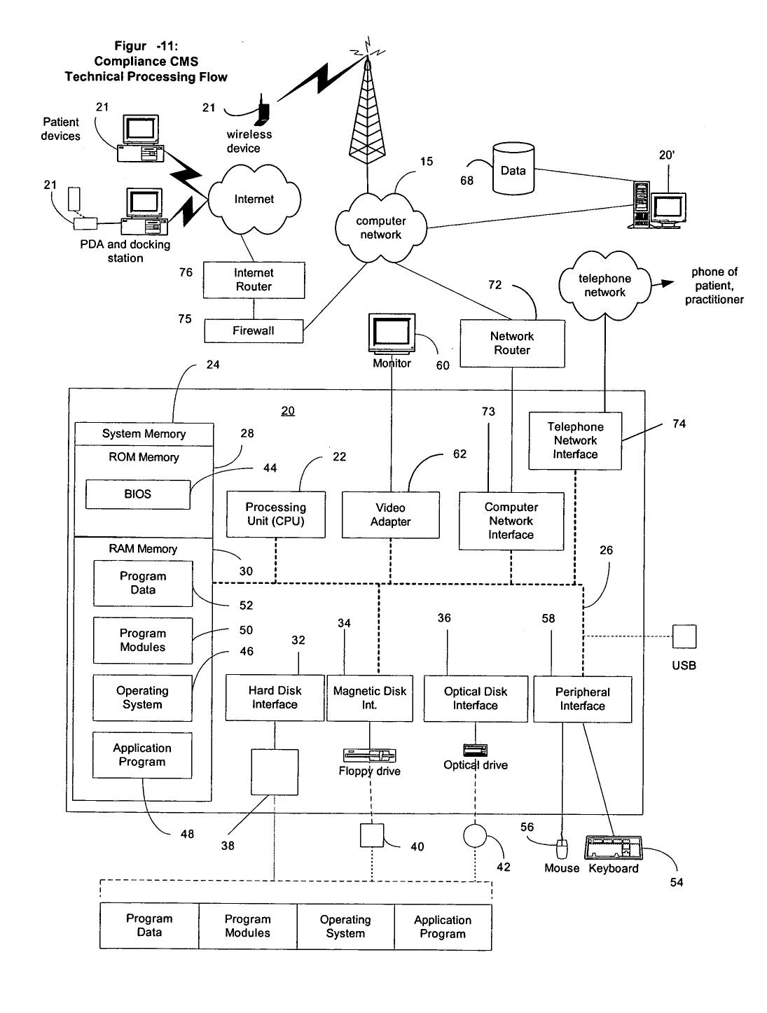

Turning now to FIGS. 9 and 10 there is illustrated an overview of a preferred use of the storage unit 68 and the flow of data, reports, mail, and messages amongst the various participants in the process. By way of example, the various participants may include, but are not limited to, the system operator, the individual or patient, the physician, the pharmacist, the medical education company, retained service bureaus and the pharmaceutical company. The various channels of information and data flow illustrated in FIGS. 9 and 10 are described below in connection with the steps illustrated in FIGS. 1-8. In this regard, it is to be appreciated that the numerical designations provided to the channels of information and data flows illustrated in FIGS. 9 and 10 correspond to the exemplary steps illustrated in FIGS. 1-8.

For gathering information for use within the system it is first preferred that the pharmaceutical company register the physician with the system (i.e., the physician has elected to participate and supplies needed information to the pharmaceutical company), whereupon, as illustrated in FIG. 1, personnel within the pharmaceutical company may convey relevant information to the system. By way of example, this information may include, but need not be limited to: a) a physician ME number; b) physician contact information; c) physician location information; d) (pharmaceutical) brand data; e) brand contacts; f) agency data; g) agency contacts. The conveyance of this data to the system for storage in system storage 68 may be either in electronic format or via facsimile transmission as defined in step 1.03. This data is either compiled directly into the server via programmed script or manually entered into the system as defined in step 1.04.

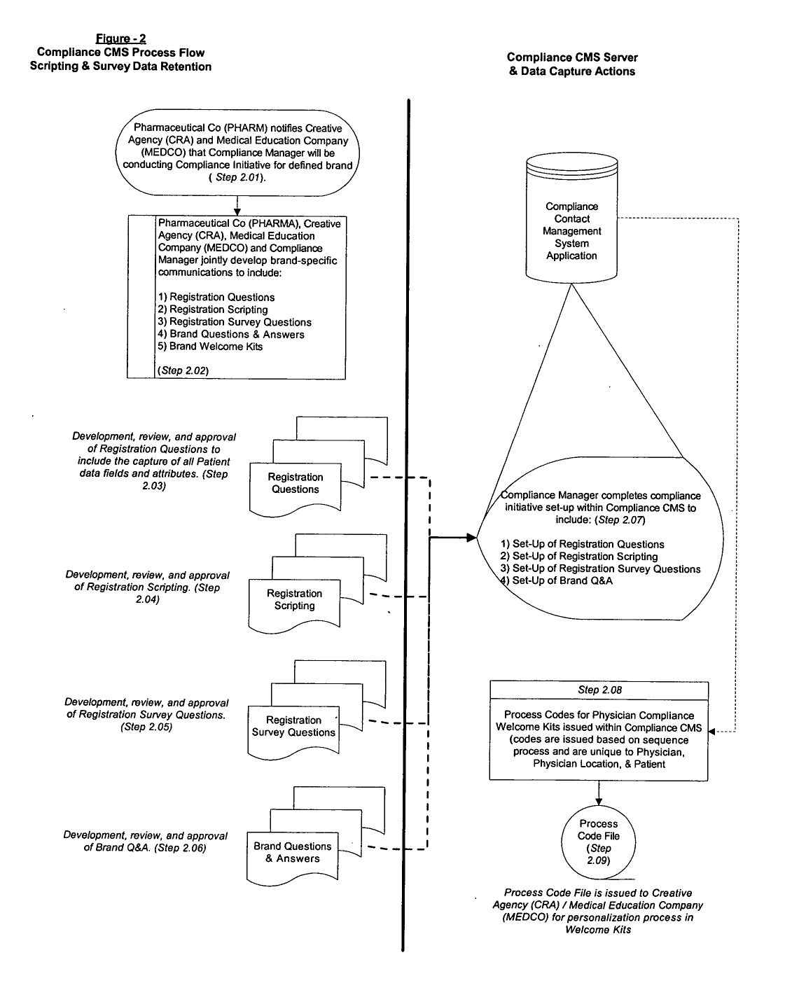

Having registered the physician, regimen configuration may be performed through the development and systemic capture of regimen scripting and survey data as generally outlined in FIG. 2. Pertinent patient registration data elements are defined as depicted in 2.03. Likewise, regimen specific scripting, regimen questions and answers (Q&A), and regimen survey questions are developed as described in 2.04, 2.05, and 2.06. All of the defined data elements are then entered into the system to facilitate future data capture on a patient-level basis as illustrated in 2.07. Generally, the patient registration data elements are defined to include generic information concerning the patient, i.e., name, age, gender, etc. and specific information that is reflective of the specific activities and/or pharmaceutical(s) to be involved in the patient regimen. Upon inception of a regimen initiative, process codes may be automatically assigned and/or printed upon welcome kits (e.g., kits including information concerning the process, a drug, information gathering surveys, etc.) to be provided by a physician to a patient. The codes would typically be indicative of a unique physician, unique physician location, or a combination of physician, location, and patient assignment designations as exemplified in 2.08. These codes are preferably issued to a creative agency/medical education company for use in preparing regimen welcome kits and unique batches of welcome kits with the unique process codes would be issued by the preparing company to each participating physician location. This process allows the system to establish physician data normalization before the registration process begins.

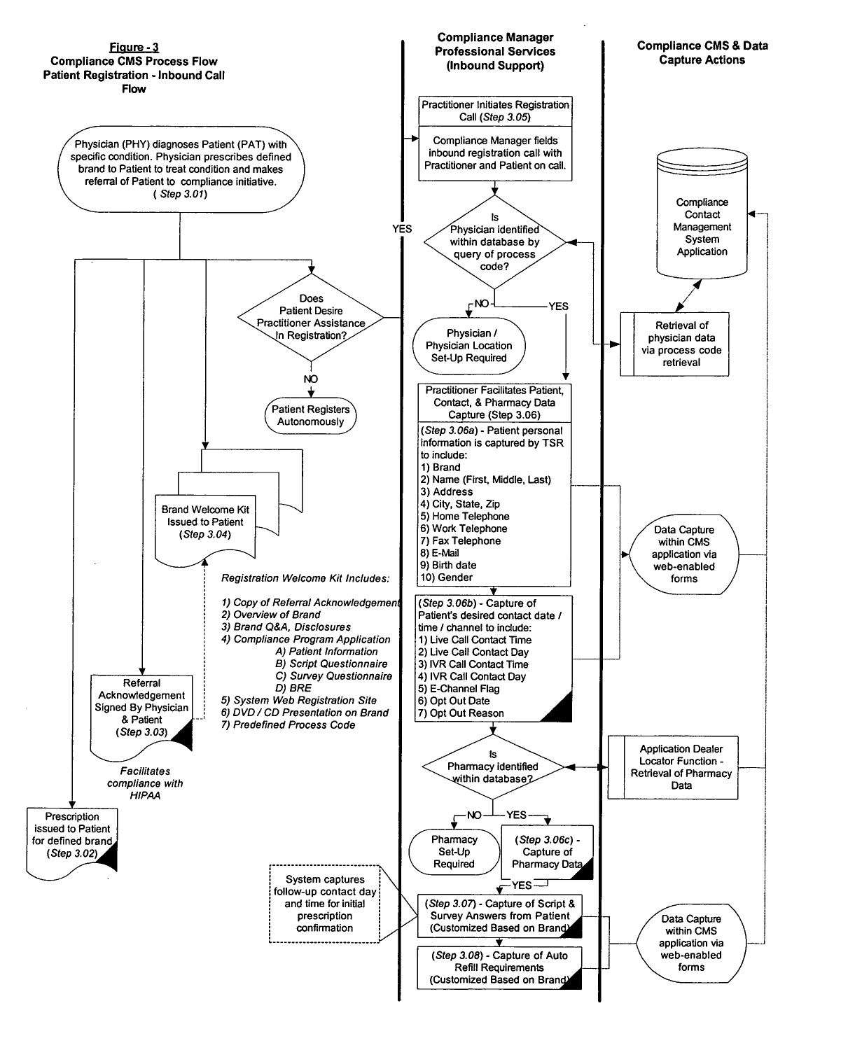

Turning now to FIG. 3, the regimen inception would occur when the physician diagnoses the patient with a specific condition and prescribes the designated drug and regimen. Additionally, under the process design, the physician would complete a referral of the patient into the compliance initiative. Currently, such referral requires a written acknowledgement, that is executed by both the physician and the patient as outlined in 3.03, 4.03, and 5.03, which acknowledgement is to be retained as required for HIPAA compliance.

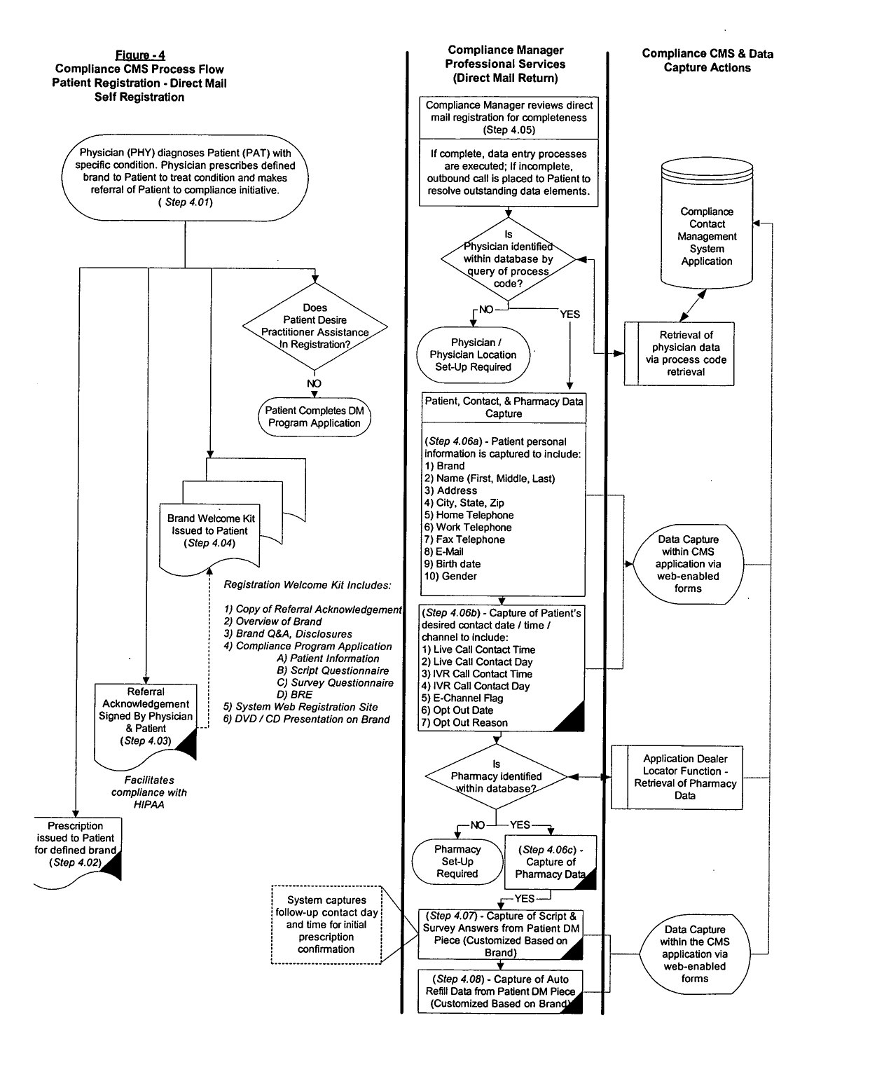

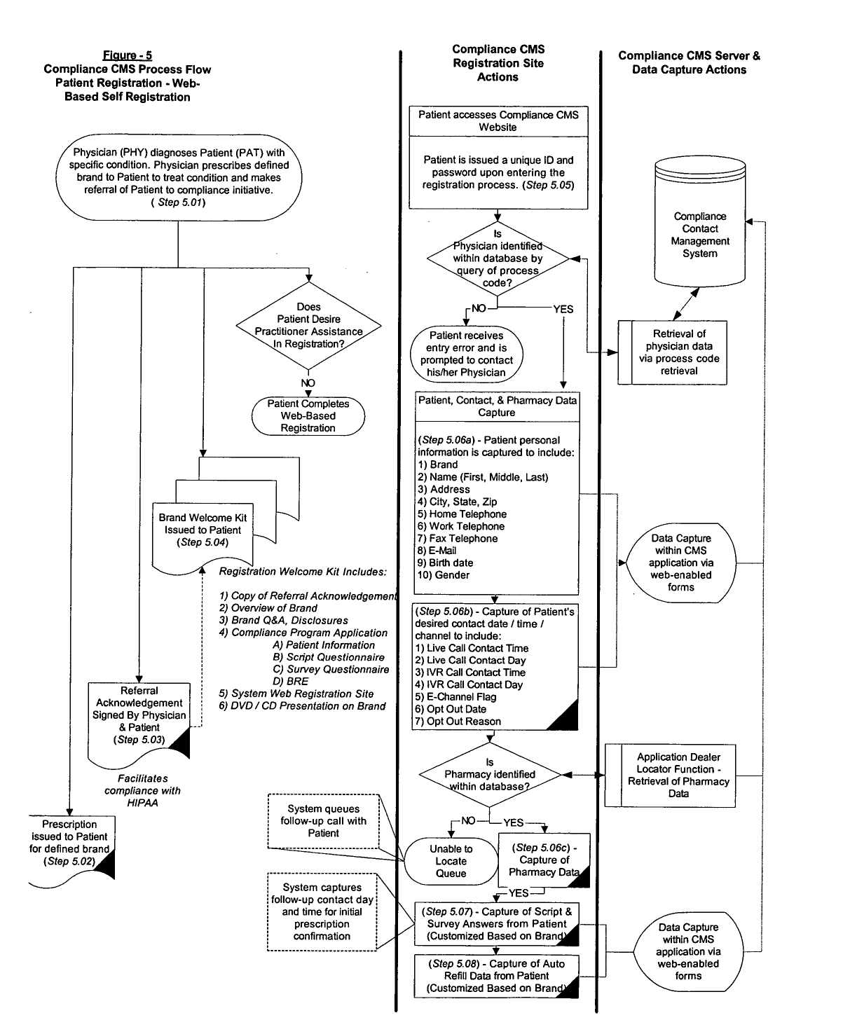

Once the patient and physician have completed the referral process, the patient is preferably issued a regimen welcome kit as detailed in 3.04, 4.04, and 5.04. It is to be understood that the welcome kit may be printed, electronic, or combination of the two. The welcome kit will include the pre assigned process code described above and may further include one or more of: a) a copy of the referral acknowledgement; b) overview of the drug and regimen; c) drug Q&A and disclosures; d) compliance program application; e) web registration guide; and f) DVD/CD presentation. Upon presentment of the welcome kit, the patient can elect to register in one of three methods as follows: a) practitioner-facilitated registration as illustrated in FIG. 3; b) self-directed mail registration as illustrated in FIG. 4; or c) web-based registration as illustrated in FIG. 5.

Should the patient elect practitioner-facilitated registration, a member of the physician's staff may place a joint call with the patient into the patient care center of the system as illustrated in 3.05. The patient registration is then completed by phone and the system is programmed to capture one or more data elements as need for a particular implementation such as: a) patient name; b) patient address; c) patient city; d) patient state; e) patient zip; f) home phone; g) work phone; h) fax phone; i) e-mail; j) birth date; k) gender; l) live call contact time; m) live call contact day; n) interactive voice (“IVR”) call contact day; o) IVR call contact time; p) e-mail flag; q) pharmacist name; r) pharmacist location; s) pharmacist phone; t) auto refill designation flag; u) refill payment processing flag; v) credit card number; w) credit card issuer; x) expiration date; y) CVV2; z) Card Type; aa) drug dosage measurement; ab) dosage duration; ac) dosage frequency; and ad) number assigned to the welcome kit provided to the patient. These data can be gathered by a live operator and manually entered into the system, may be captured by a voice response system, etc. Beyond these basic data attributes, in a preferred embodiment of the process, responses to regimen or drug-specific surveys or script questions outlined in 3.07 and 3.08 are captured.

Should the patient elect to complete the registration process via a self-directed direct mail response application, the patient would complete the application located in the welcome kit and return it to the system operator as depicted in 4.05. The returned direct mail application would generally provide the same data elements discussed above for entry into the system. Similarly, should the patient elect to complete the registration process via a self-directed, web-based application, the patient would log onto a site listed in the welcome kit as outlined in 5.05. As the patient logs into the system, the patient may be asked to provide a unique User ID and password that is retained within the system. The patient would then complete the registration to include entry of one or more of the data elements discussed above. Upon conclusion of web-based registration, the patient preferably receives a confirmation number for reference purposes.

Once the registration process has been completed, a first post-registration contact transaction may be performed by the system. To this end, the system queues as referenced in 3.07, 4.07 and 5.07, patient records for an initial prescription confirmation contact. This contact preferably occurs a time and in a manner specified by the patient and is designed to establish that the patient has engaged the regimen by retrieving the initial prescription. By way of example, the contact may include a live operator calling the patient for the purpose of gathering the appropriate information, may be accomplished by means of an IVR application that is used to gather the appropriate information, etc. In the event that it is determined that the patient has failed to acquire the prescription at the time of the contact, the system may queue a contact to the physician for notification of this fact.

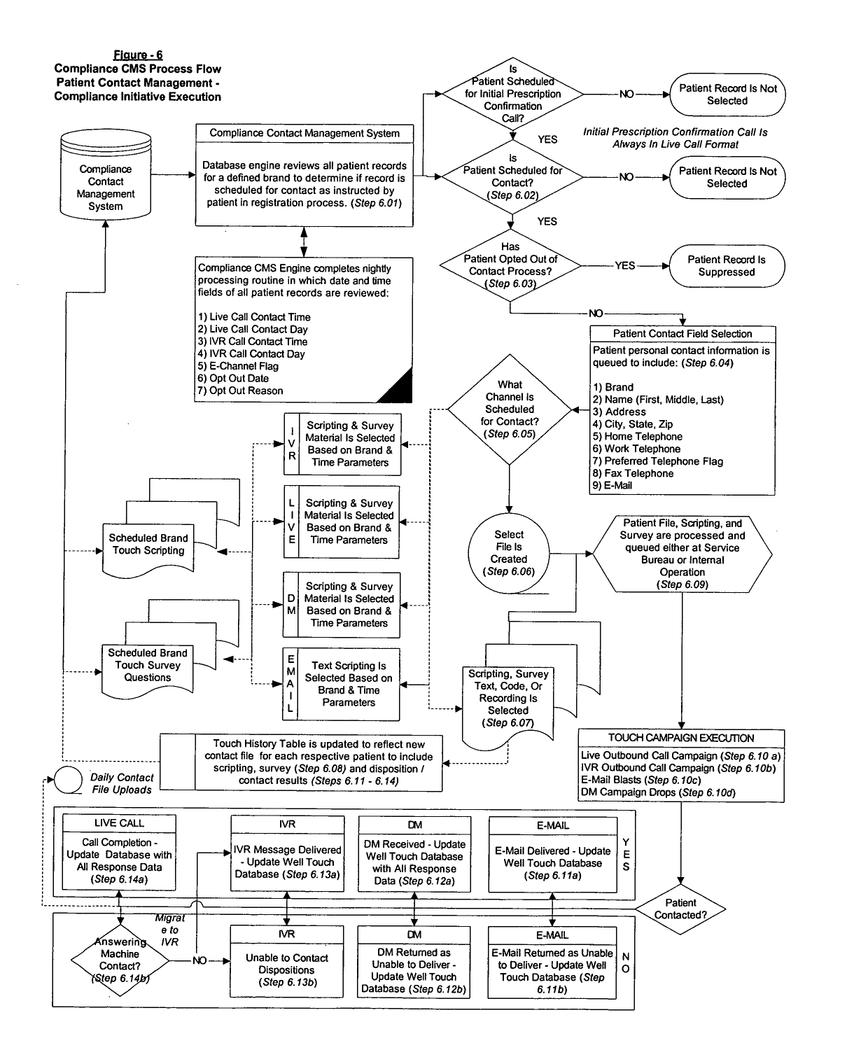

Once it has been established that a regimen has commenced, a preferred software module within the defined system may complete on a periodic basis, for example on a nightly basis, a series of queries and loop routines designed to manage further patient contact. By way of example, this module may, as illustrated in FIG. 6, perform functions to: a) identify if a patient record is eligible for a regimen contact based on the patient's expressed contact management preference; b) identify if a selected patient record has opted out of the process in a prior contact event; c) identify the respective channel by which the patient is to be contacted; d) select the appropriate survey, scripting, and/or recording files (i.e., a contacting media) to be used based on the channel identified and which is appropriate for the regimen and notification schedules.

In the event a patient is still eligible for a regimen contact, the system may then queue the eligible patient records and create one or more production files which are unique for each contact channel as referenced in 6.06 and 6.07. These files may vary by channel as illustrated in exemplary Exhibits 1 through 5 set forth below.

Exhibit - 1: E-Mail File Format
File Naming Convention - Outbound File

YYYYMMDD24HHMMSS_EMAIL_OUT.BRAND.txt
2003120524073030_EMAIL_OUT.BRAND.txt

Detail Record - File Format

JOB_TYPE - EMLT - Email Touch
Touch ID - unique identification for each touch
Brand Name
Description
Patient Name
Patient Phone Number
Patient Email Address
Date (YYYMMDD)
Time (24HHMMSS)
Associated File (EMLT_A - *.txt)

File Naming Convention - Inbound File

YYYYMMDD24HHMMSS_EMAIL_IN.BRAND.txt
2003120524073030_EMAIL_IN.BRAND.txt

Response Record

Job_Type_Response - EMLR - EMAIL Response Touch
Touch ID
Brand
Description
Patient Name
Patient Phone Number
Patient E-Mail
Date (YYYMMDD)
Time (24 HHMMSS)
Text (TOUCH RESULT)

Disposition Definitions - Inbound File

1. Delivered
2. Delivery Failure

Exhibit - 2: Live File Format
File Naming Convention - Outbound File

YYYYMMDD24HHMMSS_LIVE_OUT.BRAND.txt
2003120524073030_LIVE_OUT.BRAND.txt

Header Record

File ID - LIVH
Process Date - Call Date - MM/DD/YY
Audio File Name - File associated with touch
Script Information - Script to be used in contact

Detail Record

File ID - LIVP
Touch ID - unique identification for each touch
Brand Name
Patient Name
Patient Phone Number
Time of Day to Call
Auto Refill Code - Y/N
LIVP, 158, Brand, James Smith, (770)XXX-XXXX, 7:30 PM, N

Survey Question Record

File ID - LIVQ
Touch ID - unique identification for each
Question ID - unique assignment for questions
Question Type - (Y - Yes/No; M - Multiple; T - Text)
Multiple Choice Response 1
Multiple Choice Response 2

Patient Response Record

File ID - LIVR
Touch ID - consistent with the initiated output file
Status - disposition status code
Red-Flag Feedback - a text field capture special care
requirements of the patient
LIVR, 158, C, Patient requires physician consultation

Patient Question Response Record

File ID - LIQR
Touch ID - consistent with the initiated output file
Question ID - consistent with output survey question
Question Response - Y/N; Multiple Choice Response; or
Open Text Response
LIQR, 158, 2, N

Exhibit - 3: IVR File Format
File Naming Convention - Outbound File

YYYYMMDD24HHMMSS_IVR_OUT.BRAND.txt
2003120524073030_IVR_OUT.BRAND.txt

Detail Record - File Format

JOB_TYPE - IVRT - IVR Touch
Touch ID - unique identification for each touch
Brand Name
Description
Patient Name
Patient Phone Number
Patient Email Address
Date (YYYMMDD)
Time (24HHMMSS)
Associated File (IVRT - *.wav)

File Naming Convention - Inbound File

YYYYMMDD24HHMMSS_IVR_IN.BRAND.txt
2003120524073030_IVR_IN.BRAND.txt

Response Record

Job_Type_Response - IVRR - IVR Response Touch
Touch ID
Brand
Description
Patient Name
Patient Phone Number
Patient E-Mail
Date (YYYMMDD)
Time (24 HHMMSS)
Text (TOUCH RESULT)

Disposition Definitions - Inbound File

Delivered_To_Voice
Delivered_To_Answering_Machine
No_Dialtone
No_Ring
No_Answer
Busy
Operator_Intercept
Fax_Tone_Received
Invalid_Number
No_Voice_Detected
Call_Data_Error
Broadcast_Window_Expired
Do_Not_Contact
Unknown_Error

Exhibit - 4: SMS/Text Message File Format
File Naming Convention - Outbound File

YYYYMMDD24HHMMSS_SMS_OUT.BRAND.txt
2003120524073030_SMS_OUT.BRAND.txt

Detail Record - File Format

JOB_TYPE - SMST - SMS Touch
Touch ID - unique identification for each touch
Brand Name
Description
Patient Name
Patient Phone Number
Patient Email Address
Date (YYYMMDD)
Time (24HHMMSS)
Associated File (SMST_B - *.txt)

File Naming Convention - Inbound File

YYYYMMDD24HHMMSS_SMS_IN.BRAND.txt
2003120524073030_SMS_IN.BRAND.txt

Response Record

Job_Type_Response - SMSR - SMS Response Touch
Touch ID
Brand
Description
Patient Name
Patient Phone Number
Patient E-Mail
Date (YYYMMDD)
Time (24 HHMMSS)
Text (TOUCH RESULT)

Disposition Definitions - Inbound File

3. Delivered
4. Delivery Failure

Exhibit - 5: Ditrect Mail File Format
File Naming Convention - Outbound File

YYYYMMDD24HHMMSS_DM_OUT.BRAND.txt
2003120524073030_DM_OUT.BRAND.txt

Header Record

Filed ID - DMLH
Process Date - Drop Date - MM/DD/YY
Script Information - Script to be used in contact

Detail Record

File ID - LIVP
Touch ID - unique identification for each touch
Brand Name
Patient Name
Patient Phone Number
Time of Day to Call
Auto Refill Code - Y/N
LIVP, 158, Brand, James Smith, (770)XXX-
XXXX, 7:30 PM, N

Survey Question Record

File ID - LIVQ
Touch ID - unique identification for each
Question ID - unique assignment for questions
Question Type - (Y - Yes/No; M - Multiple; T - Text)
Multiple Choice Response 1
Multiple Choice Response 2

Patient Response Record

File ID - LIVR
Touch ID - consistent with the initiated output file
Status - disposition status code
Red-Flag Feedback - a text field capture special
care requirements of the patient
LIVR, 158, C, Patient requires physician consultation

Concurrent with queuing of the production files, a touch history table within the database 68 may be updated to reflect that the patient is queued for a contact and that a production file has been issued as illustrated in steps 6.11-6.14. As will be appreciated, the touch history table is utilized to track: which patients are to be contacted, whether a contact procedure has been utilized in connection with that patient, and the results of the attempted contact.

By way of further example, a program module within the system may process each of the respective production files posting the files via a virtual private network to either a secured FTP or secured BBS folder. Each respective production file may then be imported to either a predictive dialer application or distribution application that works in connection with the telephone network interface 74 or the computer network interface 73, respectively, whereby the contacts may be administered in the manner that has been defined by the patient. As contacts are completed and/or attempted, dispositions are captured and retained within the touch history table. Such disposition definitions are specified by contact type within the exemplary Exhibits 1 through 5.

In connection with the contact management processes, the system may also include a software module that operates at predefined times, such as on a nightly basis, to update compliance tracking data. For example, as illustrated in 6.11 through 6.15, the software may perform a series of import routines designed to: a) process returned disposition files from the day's contact campaigns; b) post dispositions to the touch history table within the storage server; and c) post batch summary reporting to provide a comprehensive reconcilement of contact dispositions by contact type and disposition code. In the event that a patient was unable to be reached, e.g., there was an unable to contact disposition, mail was returned as undeliverable, etc., the system may be adapted to repeat attempts to contact the patient, by the same or other means preferably specified by the patient. In such an instance, it may also be preferred to notify the physician of the patient that a scheduled, compliance checking contact went unanswered. The physician notification may be queued and transmitted by electronic mail, an IVR phone call, operator phone call, or the like.

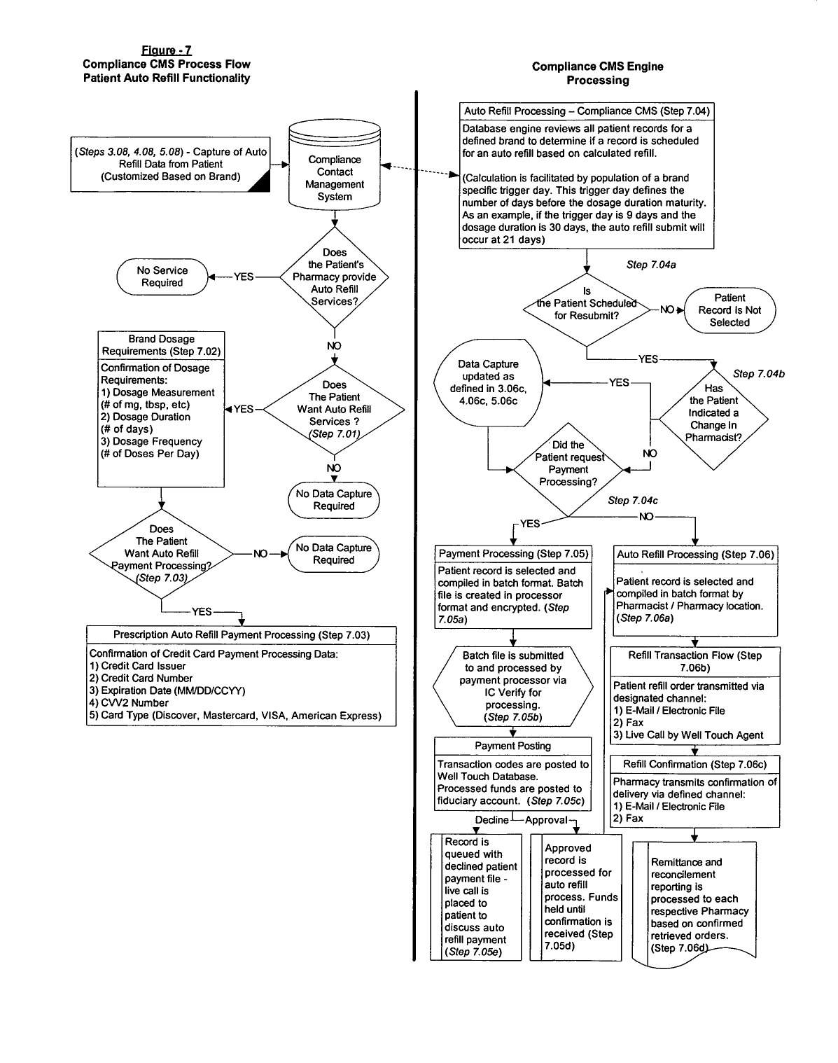

It is also contemplated that the system may be utilized to complete, for example on a dynamic basis, a series of queries and loop routines programmed to: a) identify if the patient record has an auto refill pharmacy; b) identify patient records that do not have an auto refill pharmacy and that have requested a submission of a refill request; and c) are scheduled for a prescription refill based on regimen dosage duration and the system calculated lag time as defined at the brand-level or by the physician, as illustrated in FIG. 7. Once a record has been selected for auto refill, an e-mail, facsimile, live call, electronic file, or the like is processed to include, for delivery to a designated pharmacy or drug provider, information such as: a) patient name; b) patient address; c) patient city; d) patient state; e) patient zip; f) patient phone; g) patient's physician; h) patient's physician ME number; i) dosage measurement; j) dosage duration; k) dosage frequency; and l) scheduled patient retrieval date, as illustrated in 7.01 through 7.06. The system may also be adapted to capture retrieval confirmation information from the pharmacy in a variety formats such as e-mail, electronic file, facsimile, phone call, etc.

Still further, should the patient elect to have payment processing be completed on their behalf, the system will likewise select all patient payment information into a processing batch. This information may include, but need not be limited to: a) patient name on a select credit or debit card; b) card issuer; c) card number; d) expiration date (e.g., MM/DD/CCYY); e) CVV2 number; and f) card type. The established batch of patient records is preferably encrypted via a processor's third party software and transmitted for processing. Upon return of the batch file from the processor, the system would decrypt the file and may then post authorization results to an approval history table within the database 68. It will be appreciated that the data in fields a through f described above as well as the approval codes should be transmitted to the pharmacy to allow the pharmacy to complete the refill request. By way of example, the system may process the respective production files by posting the files via a virtual private network to either a secured FTP or secured BBS folder. Each respective production file may then be imported to either a predictive dialer application or distribution application the operates in connection with the telephone network interface 74 or computer network interface 73 and the contacts are administered as defined by the patient. As contacts are completed and/or attempted, dispositions are captured and retained. Such disposition definitions are specified by contact type within exemplary Exhibits 1 through 5.

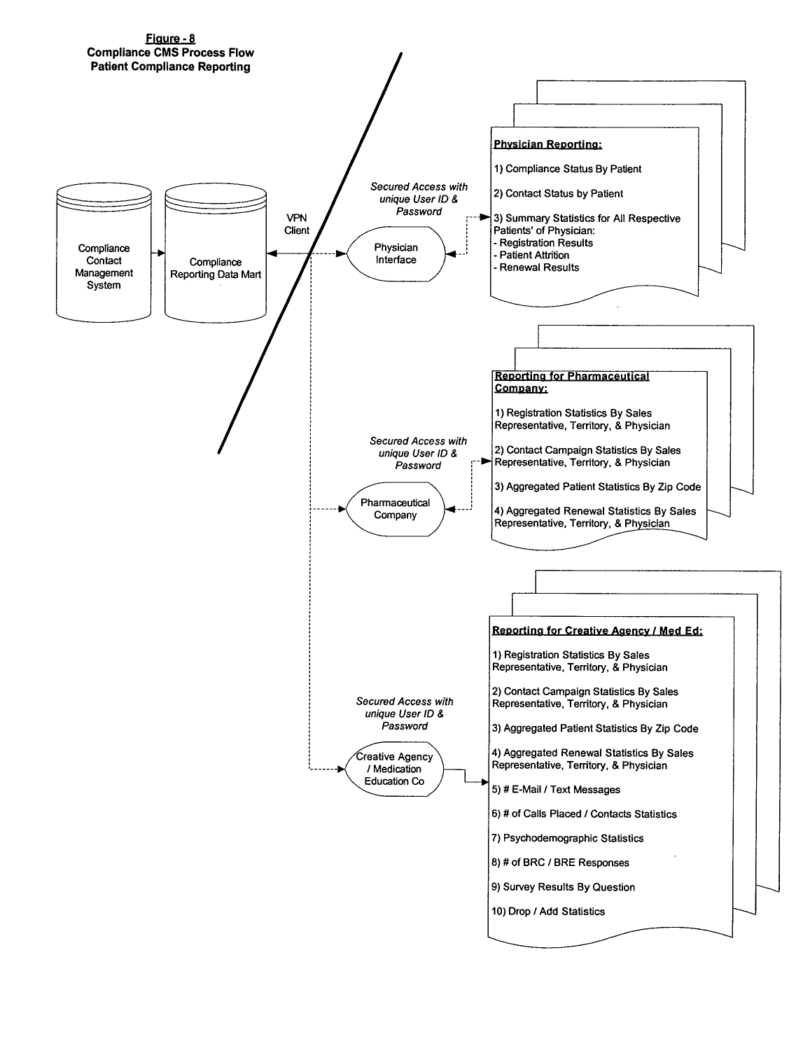

To report patient compliance, FIG. 8 illustrates exemplary steps wherein a physician, pharmaceutical company, medical education company, or the like may access the system. Preferably such access is restricted requiring a unique user ID and password. By way of example, a physician may access the system to retrieve compliance status by a patient of the physician, their contact status, and summary statistics for all of the patients of the physician. A pharmaceutical company may access the system to retrieve compliance data such as registration statistics by a sales representative, territory, or physician; contact campaign statistics by a sales representative, territory, or physician, aggregated patient statistics by a zip code or other geographic designator, renewal statistics, etc. A medical education company may desire to see the same statistical information as well as statistics concerning responses, survey results, drop/add, etc.

While various concepts have been described in detail, it will be appreciated by those skilled in the art that various modifications and alternatives to those concepts could be developed in light of the overall teachings of the disclosure. For example, while described in the context of facilitating compliance with a medical prescription regimen, it will be understood that the system and method described herein may be utilized to facilitate compliance with any regimen. Accordingly, the particular concepts disclosed are meant to be illustrative only and not limiting as to the scope of the invention which is to be given the full breadth of the appended claims and any equivalents thereof.

1. A readable media having instructions for facilitating compliance with a regimen, the instructions performing steps comprising:
identifying if an individual is eligible for a regimen contact based on an expressed contact management preference set forth in a database record associated with that individual;
identifying a channel by which the individual is to be contacted;
selecting a contacting media to be used when contacting the individual considering the channel identified and a schedule of the regimen;
attempting to contact the individual via the identified channel using the selected contacting media; and
updating a touch history table within a database wherein the touch history table is utilized to track: which individuals are to be contacted, whether a contact procedure has been utilized in connection with that individual, and results of an attempted contact.

2. The readable media as recited in claim 1, wherein the contacting media comprises a production file.

3. The readable media as recited in claim 1, wherein the instructions identify if a selected individual record indicates that the individual has opted out of the process in a prior contact event.

4. The readable media as recited in claim 2, wherein the instructions post the production file via a virtual private network to either a secured FTP or secured BBS folder.

5. The readable media as recited in claim 4, wherein the production file is imported to a predictive dialer application that works in connection with a telephone network interface whereby the contact may be administered in the manner that has been defined by the individual.

6. The readable media as recited in claim 4, wherein the production file is imported to a distribution application that works in connection with a computer network interface whereby the contact may be administered in the manner that has been defined by the individual.

7. The readable media as recited in claim 1, wherein the instructions operate at predefined times to update compliance tracking data.

8. The readable media as recited in claim 7, wherein compliance tracking data is updated by processing returned disposition files from a day's contact campaigns; posting dispositions to the touch history table; and posting batch summary reports to provide a comprehensive reconcilement of contact dispositions by contact type and disposition code.

9. The readable media as recited in claim 1, wherein the instructions attempt a further contact with the individual, by a channel specified by the individual, in the event that the individual was unable to be reached by a first attempt.

10. The readable media as recited in claim 1, wherein the instructions cause a physician of the individual to be notified that a scheduled, compliance checking contact went unanswered.

11. The readable media as recited in claim 10, wherein the physician notification is transmitted by electronic mail.

12. The readable media as recited in claim 10, wherein the physician notification is performed using an IVR phone call.

13. The readable media as recited in claim 1, wherein the instructions provide a graphical user interface accessible via a Web site by which the individual may supply contact preferences.

14. The readable media as recited in claim 1, wherein the instructions cause a pharmacy to be contacted to auto refill a prescription for a drug in response to the instructions identifying that an individual's record specifies an auto refill pharmacy and the individual is scheduled for a prescription refill based on a regimen dosage duration and a system calculated lag time.

15. The readable media as recited in claim 14, wherein the calculated lag time is defined at a brand-level for the prescribed drug.

16. The readable media as recited in claim 14, wherein the calculated lag time is define by a physician for the individual.

17. The readable media as recited in claim 14, wherein the pharmacy is contacted via an email.

18. The readable media as recited in claim 14, wherein the pharmacy is contacted via a facsimile transmission.

19. The readable media as recited in claim 14, wherein the instructions are adapted to capture retrieval confirmation information from the pharmacy.

20. A method for facilitating compliance with a regimen, comprising:
providing informational materials concerning the regimen including information that specifies one or more means by which an individual registers with a regimen compliance network;
accepting registration information from the individual by a means specified in the informational materials;
storing the registration information in a database associated with the regimen compliance network, the registration information including a contact management preference;
when the stored registration information identifies the individual as being eligible for a regimen contact, identifying a channel by which the individual is to be contacted, selecting a contacting media to be used when contacting the individual considering the channel identified, and attempting to contact the individual via the identified channel using the selected contacting media; and
updating a touch history table utilized to track: which individuals are to be contacted, whether a contact procedure has been utilized in connection with that individual, and results of an attempted contact.

21. The method as recited in claim 20, wherein the instructional materials include a process code which is indicative a physician.

22. The method as recited in claim 21, wherein the process code is provided during individual registration and allows the regimen compliance network to establish physician normalization data.

23. The method as recited in claim 20, wherein the regimen comprises a drug prescription.

24. The method as recited in claim 20, wherein the contacting media comprises a production file.

25. The method as recited in claim 20, comprising determining if an individual's record indicates that the individual has opted out of the process in a prior contact event.

26. The method as recited in claim 24, wherein the instructions post the production file via a virtual private network to either a secured FTP or secured BBS folder.

27. The method as recited in claim 26, wherein the production file is imported to a predictive dialer application that works in connection with a telephone network interface whereby the contact may be administered in the manner that has been defined by the individual.

28. The method as recited in claim 26, wherein the production file is imported to a distribution application that works in connection with a computer network interface whereby the contact may be administered in the manner that has been defined by the individual.

29. The method as recited in claim 20, comprising updating compliance tracking data at predefined times.

30. The method as recited in claim 29, wherein compliance tracking data is updated by processing returned disposition files from a day's contact campaigns; posting dispositions to the touch history table; and posting batch summary reports to provide a comprehensive reconcilement of contact dispositions by contact type and disposition code.

31. The method as recited in claim 20, comprising attempting a further contact with the individual, by a channel specified by the individual, in the event that the individual was unable to be reached by a first attempted contact.

32. The method as recited in claim 20, comprising causing a physician of the individual to be notified that a scheduled, compliance contact went uncompleted.

33. The method as recited in claim 32, comprising transmitting the physician notification by an electronic messaging system.

34. The method as recited in claim 32, comprising using an IVR phone call to provide the physician notification.

35. The method as recited in claim 32, comprising using a facsimile transmission to provide the physician notification.

36. The method as recited in claim 20, wherein a means by which an individual registers with the regimen compliance network comprises accessing a Web site by which information including contact preferences is electronically submitted for entry into the regimen compliance network.

37. The method as recited in claim 20, wherein a means by which an individual registers with the regimen compliance network comprises transmitting via mail information including contact preferences for entry into the regimen compliance network.

38. The method as recited in claim 20, wherein a means by which an individual registers with the regimen compliance network comprises phoning a representative of the regimen compliance network to supply information including contact preferences for entry into the regimen compliance network.

39. The method as recited in claim 20, comprising causing a pharmacy to be contacted to auto refill a prescription for a drug in response to identifying that an individual's record specifies an auto refill pharmacy and the individual is scheduled for a prescription refill based on a regimen dosage duration and a system calculated lag time.

40. The method as recited in claim 39, wherein the calculated lag time is defined at a brand-level for a prescribed drug.

41. The method as recited in claim 39, wherein the calculated lag time is define by a physician for the individual.

42. The method as recited in claim 39, comprising contacting the pharmacy via an email.

43. The method as recited in claim 39, comprising contacting the pharmacy via a facsimile transmission.

44. The method as recited in claim 39, comprising capturing retrieval confirmation information from the pharmacy.

45. The method as recited in claim 20, comprising registering a physician with the regimen compliance network and indicating a correspondence between registered individuals and registered physicians.
